(19) United States
(12) Patent Application Publication
(10) Pub. No.: US 2009/0214158 A1
(43) Pub. Date: Aug. 27, 2009

(54) Optical Printed Circuit Board and An Optical Module Connected to the Optical Printed Circuit Board

(75) Inventors: Tae Woo Lee, Daejeon (KR); Hyo Hoon Park, Daejeon (KR); Do Won Kim, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: ICU RESEARCH AND INDUSTRIAL COOPERATION GROUP, Daejeon (KR)

(21) Appl. No.: 12/346,305

(22) Filed: Dec. 30, 2008

(30) Foreign Application Priority Data
Feb. 26, 2008 (KR) 10-2008-0017405
Feb. 26, 2008 (KR) 10-2008-0017423
May 7, 2008 (KR) 10-2008-0042433
May 7, 2008 (KR) 10-2008-0042454

(51) Int. Cl. G02B 6/12; G02B 6/38; B23P 11/00

(52) U.S. Cl. 385/14; 385/55; 29/428

(57) ABSTRACT

An optical printed circuit board having an optical waveguide of at least one channel formed therein is provided. The optical waveguide of the at least one channel is stacked in the optical printed circuit board, and has both ends exposed on a surface of the optical printed circuit board and a predetermined length. An optical module is provided which can be optically aligned with the optical printed circuit board or another optical component through guide pins inserted into guide holes.

### BACKGROUND

1. Field of the Invention

The present invention relates to an optical printed circuit board and an optical module connected to the same, and more particularly, to an optical printed circuit board capable of being optically connected to an external optical component without forming a connection groove in a board surface or mounting an additional optical connector block on the connection groove, and an optical module in which an optical connection to the optical printed circuit board or an external optical component can be packaged in an assembly type.

2. Description of the Related Art

Optical transmission/connection technology has been receiving attention according to recent demands for high-capacity data transmission. However, in order to generalize the optical transmission/connection technology, it is necessary to develop optical transmission/connection techniques that are capable of minimizing optical loss in optical transmission between optical printed circuit boards or between an optical printed circuit board and optical devices and stably operating regardless of variation of an external environment or action of physical force.

Specifically, since the optical loss in an optical connection system is usually caused by misalignment of an optical waveguide at a connection boundary surface between optical devices, a new method is needed for fundamentally eliminating a misalignment possibility of the optical waveguide in a connection structure of an optical printed circuit board and optical devices. Referring to the prior art, a conventional optical printed circuit board includes a horizontal optical waveguide running horizontally within the board. For an optical connection between an optical module of an optical transceiver device/module mounted on a surface and an optical waveguide of the optical printed circuit board, an additional structure and component are needed to switch a path of the horizontal optical waveguide of the optical printed circuit board in a surface direction.

For example, a method of forming a connection groove in a surface of an optical printed circuit board, exposing an end of an internal optical waveguide to a side surface of the connection groove, and inserting an optical connector block having the optical waveguide bent at 90 degrees into the connection groove has been used. However, this conventional structure has a problem in that a process of assembling the optical connector block into the connection groove is inconvenient, a possibility of misarrangement between the optical waveguide of the optical connector block inserted into the connection groove and the optical waveguide of the optical printed circuit board is high, and it has weakness to external impact or vibration.

### SUMMARY

An object of the present invention is to provide an optical printed circuit board in which an optical waveguide of the optical printed circuit board can be connected to another optical printed circuit board by providing an integrated optical waveguide given by forming an optical connection port at an end of the optical waveguide of a predetermined length without forming a connection groove in the optical printed circuit board.

Another object of the present invention is to provide an optical printed circuit board in which horizontal and vertical regions of an optical waveguide are formed from one optical waveguide.

Still another object of the present invention is to provide an optical printed circuit board that can eliminate optical loss, inconvenience in packaging, and weakness to vibration and impact, due to assembling an optical connector block as an additional component into the connection groove formed in an optical printed circuit board.

Yet another object of the present invention is to provide an optical module of high optical efficiency that can facilitate an optical connection in an assembly type when the optical module is optically connected to an optical printed circuit board or another optical component.

Still yet another object of the present invention is to provide an optical module that can protect optical devices of the optical module from external environments and have high durability in an optical connection.

According to an aspect of the present invention, there is provided an optical printed circuit board including: an optical waveguide of at least one channel formed therein, wherein the optical waveguide of the at least one channel is stacked in the optical printed circuit board and has both ends exposed on a surface of the optical printed circuit board and a predetermined length, and includes a horizontal region bent and horizontally extending from at least one side toward an upper surface of the board and a vertical region extending toward the upper surface of the board. At least one end of the optical waveguide is connected to an optical connection port for supporting the end of the optical waveguide and the optical connection port connected to the optical waveguide is integratedly formed with the optical printed circuit board.

According to the present invention, at least one optical connection port may support a bent portion of the optical waveguide. The optical printed circuit board may further include: a support for supporting the horizontal region of the optical waveguide and the optical connection port is connected to the support. According to the present invention, the optical connection port may linearly support the optical waveguide and the optical waveguide may be bent between the horizontal region and the optical connection port.

According to the present invention, at least two guide holes or at least two guide pins for guiding optical alignment with an optical component to be mounted may be formed in an upper or side surface of the optical printed circuit board or a surface of the optical connection port adjacent to an end surface of the optical waveguide, and the guide holes or pins may be connected to corresponding guide pins or holes and optical alignment and an optical connection between optical waveguides may be made.

According to another aspect of the present invention, there is provided a method of manufacturing an optical printed circuit board, including: (a) connecting an optical connection port to a bent portion of an end of an optical waveguide to manufacture an integrated optical waveguide component; (b) providing a first board in which a through-hole for inserting the optical connection port is formed; (c) inserting the optical connection port into the through-hole to expose an end surface of the optical waveguide on a board surface, and stacking the integrated optical waveguide component on the first board; and (d) stacking and press-forming a second board on the first board having the integrated waveguide component disposed therein. Here, a support for supporting the integrated optical waveguide component is provided, and step (a) includes: arranging a horizontal region of the optical waveguide on the support and connecting the optical connection port to the support to have an assembly form.

According to still another aspect of the present invention, there is provided a method of manufacturing an optical printed circuit board, including: (a) connecting an optical connection port for linearly supporting an end of an optical waveguide to manufacture an integrated optical waveguide component; (b) providing a first board in which a through-hole for inserting the optical connection port is formed; (c) bending the optical waveguide, inserting the optical connection port into the through-hole to expose an end surface of the optical waveguide on a board surface, and stacking the integrated optical waveguide component on the first board; and (d) stacking and press-forming a second board on the first board having the integrated waveguide component disposed therein.

According to yet another aspect of the present invention, there is provided an optical module optically connectable to an optical printed circuit board, including: an optical module board in which at least one optical device is integrated and at least two guide holes are formed; and an optical connection block having at least one optical waveguide as an optical path and at least two guide holes aligned with the guide holes of the board, wherein optical path alignment between the optical module and another optical component is provided by guide pins inserted through the guide holes of the optical module board and the optical connection block and guide holes formed in the optical printed circuit board to which the optical module is connected.

According to the present invention, a protective layer may be formed of a filling material which covers the optical module board and a mounting groove for mounting the optical connection block over the at least one optical device may be formed in the protective layer of the board. The mounting groove having a first groove formed on the optical device and a second groove connected to an upper portion of the first groove and extending further than the first groove may be formed in a stepped shape and the guide holes of the optical module board may be formed to extend to the protective layer.

According to still yet another aspect of the present invention, there is provided an optical connection structure of an optical module on an optical printed circuit board. The optical module includes: an optical module board in which at least one optical device is integrated and at least two guide holes are formed; at least one optical waveguide as an optical path and at least two guide holes aligned with the guide holes of the optical module board; and guide pins inserted through the guide holes. The optical module is mounted on a portion separated from an end surface of the optical waveguide on a surface of the optical printed circuit board, a second optical connection block is optically aligned and mounted by the guide pins over the end surface of the optical waveguide of the optical printed circuit board, and an optical connection block of the optical module and the second optical connection block are connected by an optical fiber.

According to the present invention, an optical waveguide is bent to a board surface within an optical printed circuit board and both ends thereof are exposed on the board surface, such that neither assembly of an additional optical connector block nor formation of a connection groove in the optical printed circuit board is needed to make an optical path of the optical printed circuit board directed to the board surface. Since an optical connection port is integrated with the optical printed circuit board, it is resistant to external impact or vibration. An optical module can be integrated on an optical printed circuit board, thereby simplifying a packaging process and improving integration.

According to the present invention, since an optical module and another optical component such as an optical printed circuit board are assembled by guide pins, assembly and optical alignment are facilitated and optical efficiency through high optical alignment in a bonding portion is improved. Since a protective layer protects an optical module board and optical devices, the protection of the optical devices and the durability of the optical module are improved. According to the present invention, a structure in which a low surface of an optical module faces an optical printed circuit board can be formed without reversing the optical module to be connected to the optical printed circuit board, thereby easily detecting a light irradiation state.

### BRIEF DESCRIPTION OF THE DRAWINGS

FIG. 1 is a cross-sectional view of an optical printed circuit board according to an exemplary embodiment of the present invention.

FIG. 2 is a cross-sectional view of an optical printed circuit board according to another exemplary embodiment of the present invention.

FIG. 3 is a cross-sectional view of an optical printed circuit board according to still another exemplary embodiment of the present invention.

FIG. 4 is a perspective view illustrating guide pins and guide holes disposed in an optical printed circuit board according to an exemplary embodiment of the present invention.

FIG. 5 is a cross-sectional view of an optical printed circuit board according to still another exemplary embodiment of the present invention.

FIG. 6 is a perspective view of the exemplary embodiment shown in FIG. 5.

FIGS. 7 to 9 are views illustrating a method of manufacturing the optical printed circuit board shown in FIG. 1.

FIGS. 10 to 12 are views illustrating a method of manufacturing the optical printed circuit board shown in FIG. 2.

FIGS. 13 to 15 are views illustrating a method of manufacturing the optical printed circuit board shown in FIG. 5.

FIG. 16 is a view of an optical connection structure of an optical module according to an exemplary embodiment of the present invention.

FIG. 17 is a view of an optical connection structure of an optical module according to another exemplary embodiment of the present invention.

FIGS. 18 to 20 are cross-sectional views of an optical module structure according to an exemplary embodiment of the present invention.

FIG. 21 is a cross-sectional view of an optical module structure according to another exemplary embodiment of the present invention.

### DETAILED DESCRIPTION OF EXEMPLARY EMBODIMENTS

Hereinafter, exemplary embodiments of the present invention will be described with reference to the accompanying drawings.

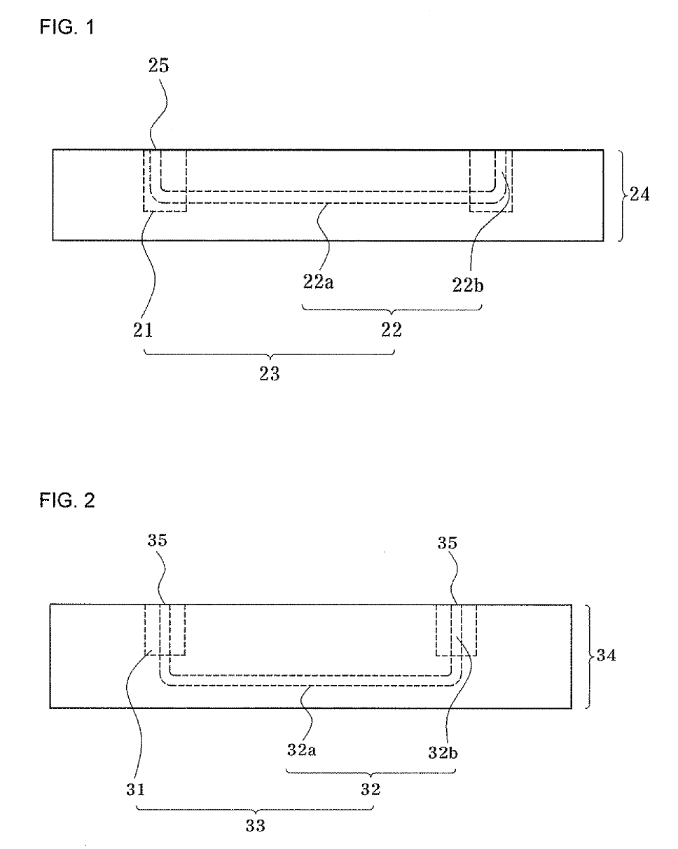

FIGS. 1 to 5 are cross-sectional views of optical printed circuit boards according to exemplary embodiments of the present invention.

An optical printed circuit board 24, 34, or 44 according to the present invention includes an optical waveguide 22, 32, or 42 of at least one channel and has a structure provided by forming a horizontal region 22a, 32a, or 42a of the optical waveguide extending horizontally by bending the optical waveguide of a predetermined length 90 degrees or vertically and a vertical region 22b, 32b, or 42b of the optical waveguide bent and extending from the horizontal region 22a, 32a, or 42a to an upper surface of the board. Since the horizontal region 22a, 32a, or 42a as a horizontal optical path and the vertical region 22b, 32b, or 42b in which the optical path is switched at 90 degrees are formed by bending one optical waveguide, a connection part of the optical waveguide is absent within the board, such that the misalignment and free-space gap of the optical waveguide capable of being generated in the connection part cannot occur.

An end surface 25, 35′ or 45 of the optical waveguide is exposed on the board surface and an optical module is packaged thereon to be optically connected.

In the present invention, the optical waveguide can be formed of an optical fiber ribbon or polymer optical waveguide film.

In a direction of the optical waveguide, the terms “90 degrees” and “vertical” includes the meaning of an angle at which light may be substantially incident in a numerical aperture (NA) range of the optical waveguide even when the angle is actually outside of 90 degrees. An angle in the above-described range may have substantially the same meaning as “90 degrees” or “vertical”.

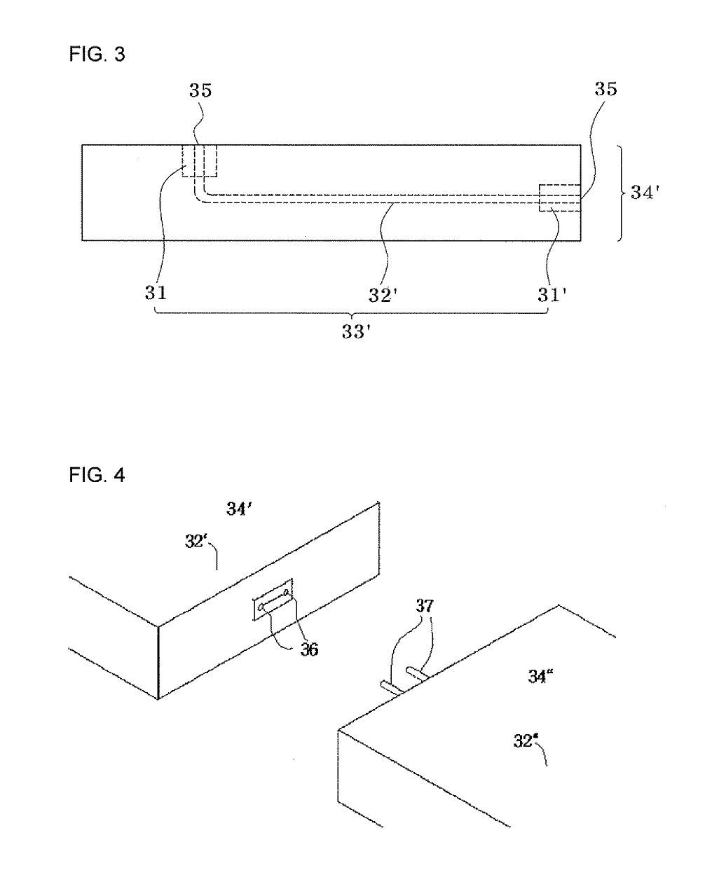

An optical connection port 21, 31, or 41 is connected to an end of the optical waveguide 22, 32, or 42, thereby forming an integrated optical waveguide component 23, 33, or 43. The optical connection port 21, 31, or 41 supports the end of the optical waveguide 22, 32, or 42 and is integrated on the optical printed circuit board 24, 34, or 44 through a press-forming process, thereby supporting an end surface of the optical waveguide in a state in which an end surface 25, 35, or 45 of the optical waveguide is exposed on an upper surface of the board as shown in FIGS. 1, 2, and 5 or a side surface of the board shown in FIG. 3.

The optical connection port may be connected to a transmitting side, a receiving side, or both sides. The optical connection port 21, 31, or 41 is a structure for supporting the end of the optical waveguide 22, 32, or 42. The end surface of the optical waveguide 22, 32, or 42 may be correctly arranged to be connectable to a predetermined position of the optical printed circuit board. Since the optical connection port 21, 31, or 41 is the structure for supporting the end of the optical waveguide, it is distinguished from a conventional optical connector connected to an optical waveguide by embedding an additional optical waveguide.

According to the present invention, the optical connection port 21, 31′ or 41 may support a bent portion of the optical waveguide 22, 32, or 42 or linearly supports the optical waveguide 22, 32, or 42. When the optical connection port supports the optical waveguide in a linear state in the optical printed circuit board, the optical waveguide is bent in a vertical direction between the horizontal region and the optical connection port.

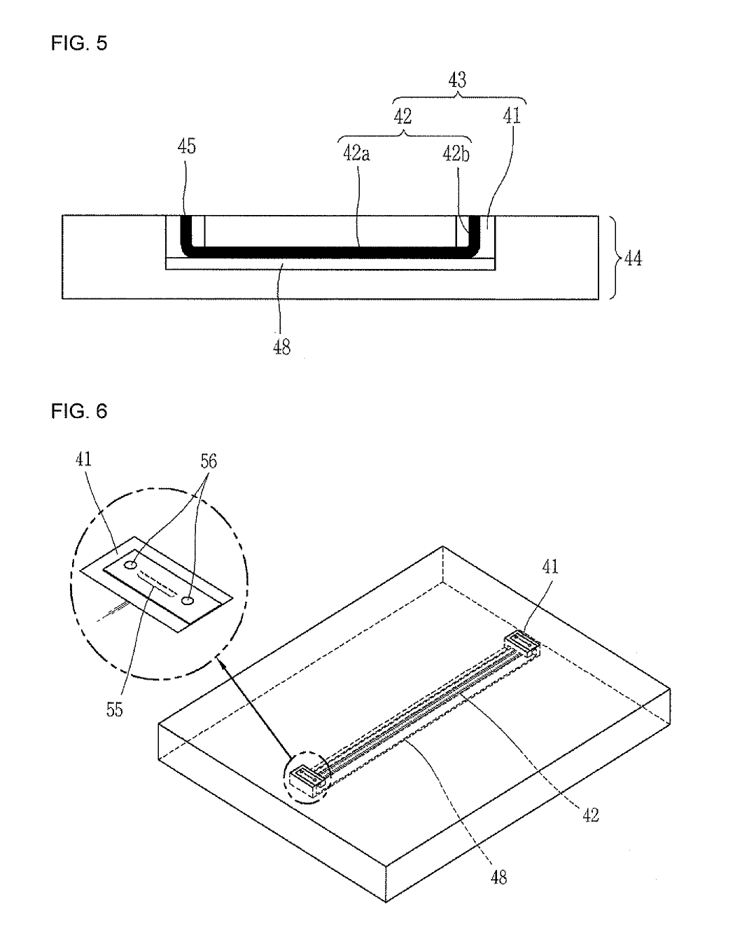

Referring to FIGS. 1 and 5, the optical connection port 21 or 41 supports the bent portion of the optical waveguide 22 or 42. Accordingly, the bent portion of the optical waveguide is placed inside the optical connection port.

Referring to FIG. 2, the optical connection port 31 linearly supports the vertical region of the optical waveguide 32. Accordingly, the bent portion of the optical waveguide 32 is placed between a horizontal region 32a of the optical waveguide and the optical connection port 31. As described above, the bent portion of the optical waveguide may be formed at any position inside and outside the optical connection port.

Referring to FIG. 3, one optical connection port 31 of two optical connection ports 31 and 31′ is installed such that an end surface 35 of an optical waveguide 32′ is exposed on an upper surface of an optical printed circuit board 34′ and the other optical connection port 31′ is installed such that an end surface 35 of the optical waveguide 32′ is exposed on a side surface of the optical printed circuit board 34′.

Referring to FIG. 4, two optical printed circuit boards 34′ and 34″ manufactured to expose the end surfaces of the optical waveguides 32′ and 32″ on the side surfaces of the boards as shown in FIG. 3 are connected to each other. The optical printed circuit boards 34′ and 34″ respectively include guide holes 36 and guide pins 37 corresponding to the optical waveguides 32′ and 32″. A configuration in which the optical waveguides 32′ and 32″ are optically connected to each other through a connection of the guide holes 36 and the guide pins 37 is shown. The end surface of the optical waveguide 32′ exposed on the side surface of the board may be optically connected to an external device by connecting an external optical waveguide film or optical fiber ribbon to the guide holes 36 using guide pins. In this case, an end of the external optical waveguide film or optical fiber ribbon is connected to the guide holes 36 of the end surface of the optical waveguide 32′ using the guide pins by attaching optical connection ports having the guide holes.

The guide holes 36 and the guide pins 37 for the optical alignment are made of conductive materials such as metal, etc., thereby supplying power through a mutual connection of the guide holes 36 and the guide pins 37.

Referring to FIG. 5, an optical printed circuit board 44 according to the present invention includes a support 48. The support 48 supports a horizontal region 42a of an optical waveguide and an optical connection port 41 is connected to the support 48. By the support 48 in the present invention, arrangement of the optical waveguide 42, handling of the horizontal region 42a and the optical connection port 41, and adjustment of a length of the optical waveguide 42 may all be easily performed. In a process of manufacturing the optical printed circuit board 44, a length of the horizontal region 42a of the optical waveguide may be constantly maintained and the effect of protection from mechanical impact may be achieved.

FIG. 6 is a perspective view of the exemplary embodiment shown in FIG. 5. A plurality of optical waveguides 42 are arranged side by side, thereby forming an optical waveguide channel array. The optical waveguides 42 are arranged along an upper surface of a support 48.

Guide holes 56 are formed at both sides of an end-surface array 55 of the optical waveguides 42 exposed on the board surface. The guide holes 56 are formed by mechanical drilling or laser drilling by micro-machining technology. The guide holes 56 are formed in a surface of the optical connection port 41, but are not limited thereto and may be formed in a surface of the optical printed circuit board around the end-surface array 55 of the optical waveguide. The guide holes 56 are used for optical alignment of an optical module in an assembly type. The optical alignment may be achieved by forming guide holes at an optical module side and inserting guide pins into the guide holes of the optical module and the board.

An optical printed circuit board in the present invention may be configured by combining a structure in which the end surface 35 of the optical waveguide 32′ and one end of the optical connection port 31 are exposed on the side surface of the optical printed circuit board as illustrated in FIG. 3 with a structure in which the end surface 25, 35, 45, or 56 of the optical waveguide 22a, 32a, 42a, or 42 and the optical connection port 21, 31, or 41 are exposed on the upper surface of the optical printed circuit board as illustrated in FIG. 1, 2, 5, or 6, excluding FIG. 3.

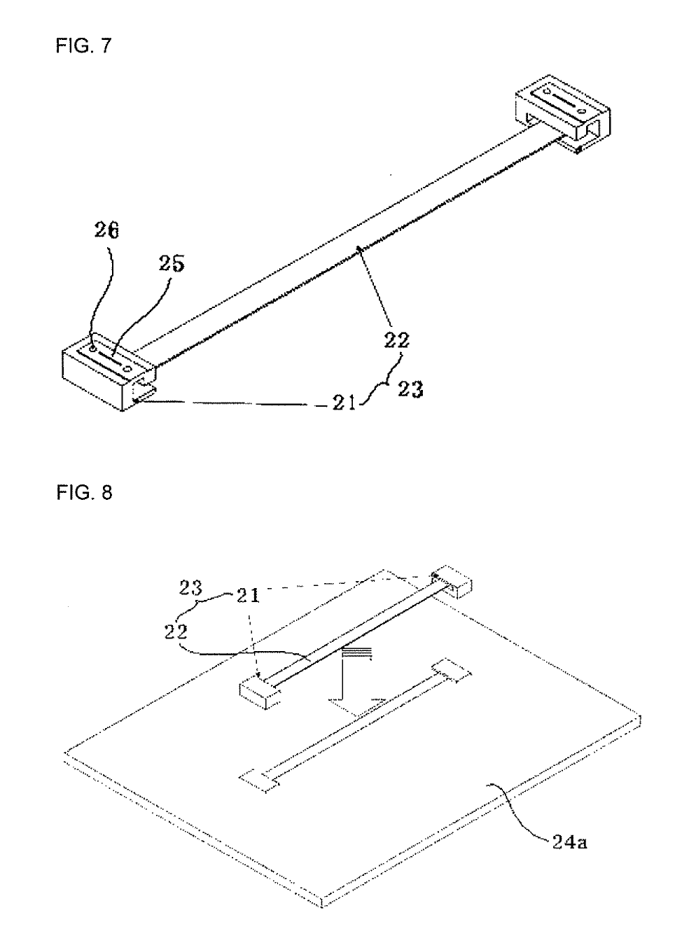

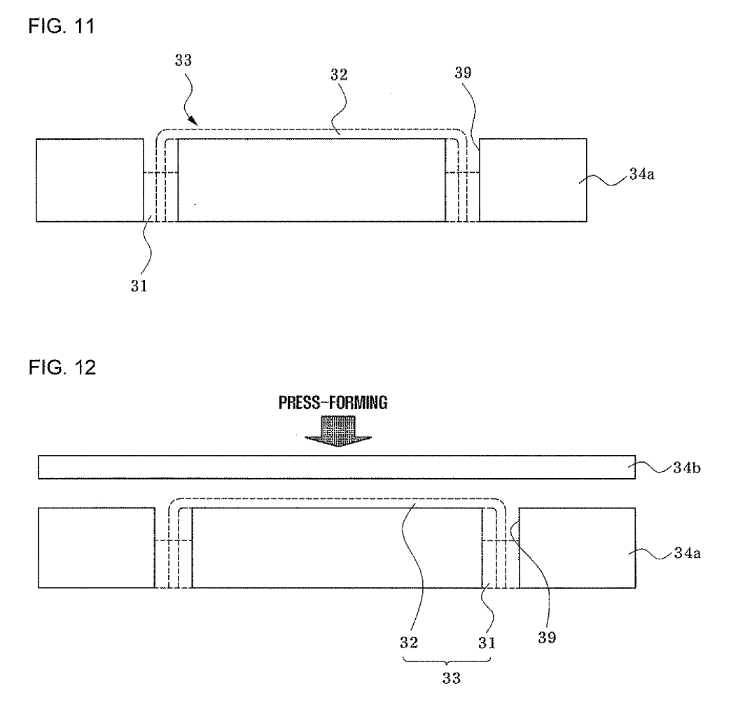

FIGS. 7 to 15 are views illustrating methods of manufacturing the optical printed circuit board according to the present invention.

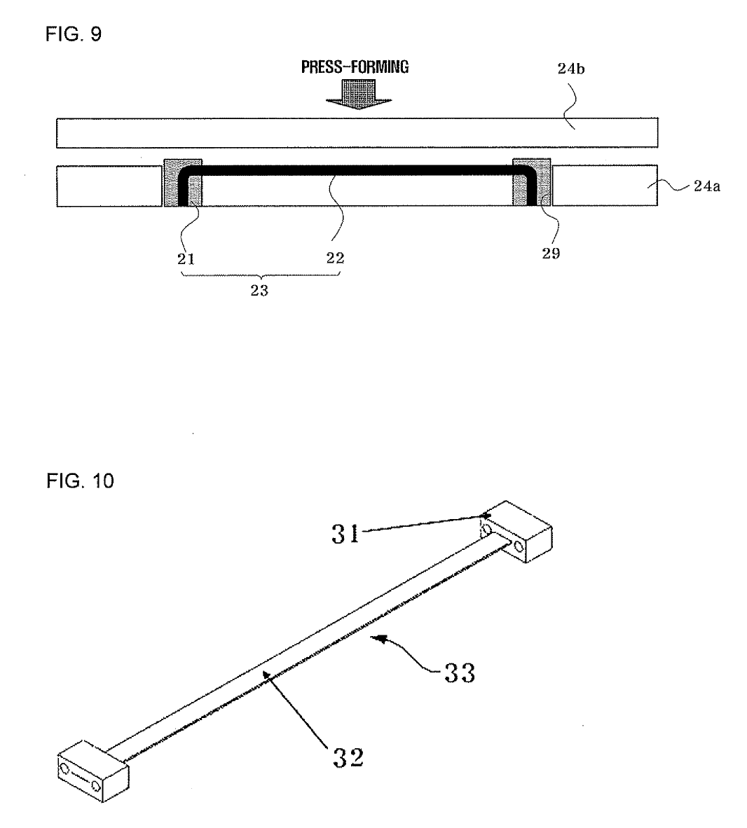

First, FIGS. 7 to 9 are views illustrating a method of manufacturing the optical printed circuit board shown in FIG. 1. Referring to FIG. 7, the optical waveguide 22 is configured in a type of array having a plurality of optical waveguide channels. An integrated optical waveguide component 23 is manufactured by connecting optical connection ports 21 to both ends of the optical waveguide 22. The optical waveguide 22 is vertically bent around the ends and bent portions are supported by the optical connection ports 21 (see FIG. 9). In the surface of the optical connection port 21, the guide holes 26 are formed at both sides of the arrangement of the optical waveguide end-surface 25.

Referring to FIG. 8, the first board 24a is provided and the integrated optical waveguide component 23 is stacked on an upper portion of the first board 24a. In the first board 24a, the through-holes 29 are formed at predetermined positions to be connected to the optical connection ports 21 (see FIG. 9). When the integrated optical waveguide component 23 is stacked, the optical connection ports 21 are inserted through the through-holes 29, thereby exposing the end surface 25 of the optical waveguide on the board surface.

Referring to FIG. 9, the second board 24b is stacked on the first board 24a having the integrated optical waveguide component 23 disposed therein. A press-forming process is performed to integrate the first board 24a, the integrated optical waveguide component 23, and the second board 24b. Through this press-forming process, the optical printed circuit board into which parts are integrated is manufactured.

FIGS. 10 to 12 are views illustrating a method of manufacturing the optical printed circuit board shown in FIG. 2. The manufacturing method shown in FIGS. 10 to 12 has the same principle as that shown in FIGS. 7 to 9. In this regard, since the optical connection ports 31 linearly support the ends of the optical waveguide 32, the difference is that the optical connection ports 31 are inserted into through-holes 39 by vertically bending the optical waveguide 32 when the integrated optical waveguide component 33 is stacked on the first board 34a.

The manufacturing method shown in FIGS. 10 to 12 will be sequentially described. The steps of manufacturing the integrated optical waveguide component 33 by connecting the optical connection ports 31 to linearly support the ends of the optical waveguide 32, providing a first board 34a in which the through-holes 39 for insertion of the optical connection ports 31 are formed, stacking the integrated optical waveguide component 33 on the first board 34a to which the optical connection ports 31 are vertical, and stacking and press-forming a second board 34b on the first board 34a having the integrated optical waveguide 33 disposed therein are sequentially performed.

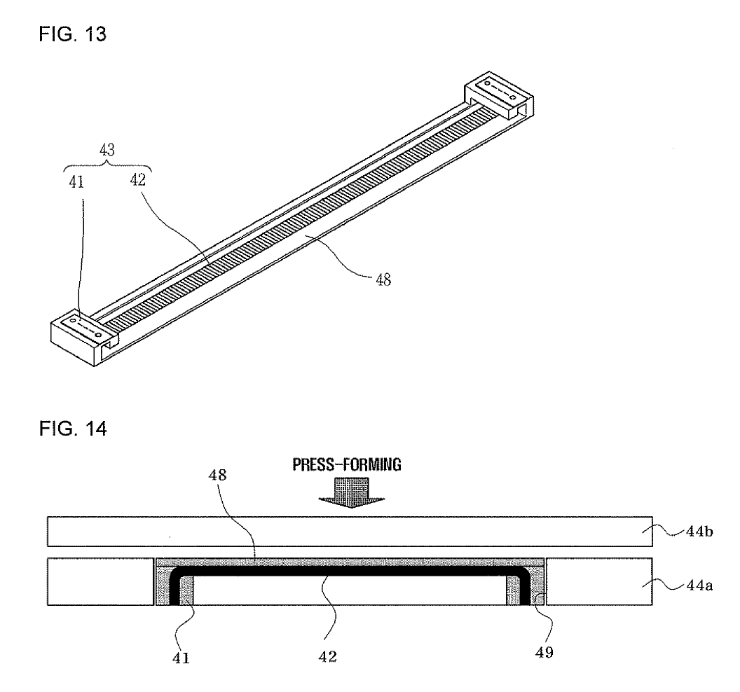

FIGS. 13 to 15 are views illustrating a method of manufacturing the optical printed circuit board shown in FIG. 5. When the manufacturing method shown in FIGS. 13 to 15 is compared with that shown in FIGS. 7 to 9, the two methods are substantially the same except for a difference that an assembly is manufactured by connecting the integrated optical waveguide component 43 to the support 48.

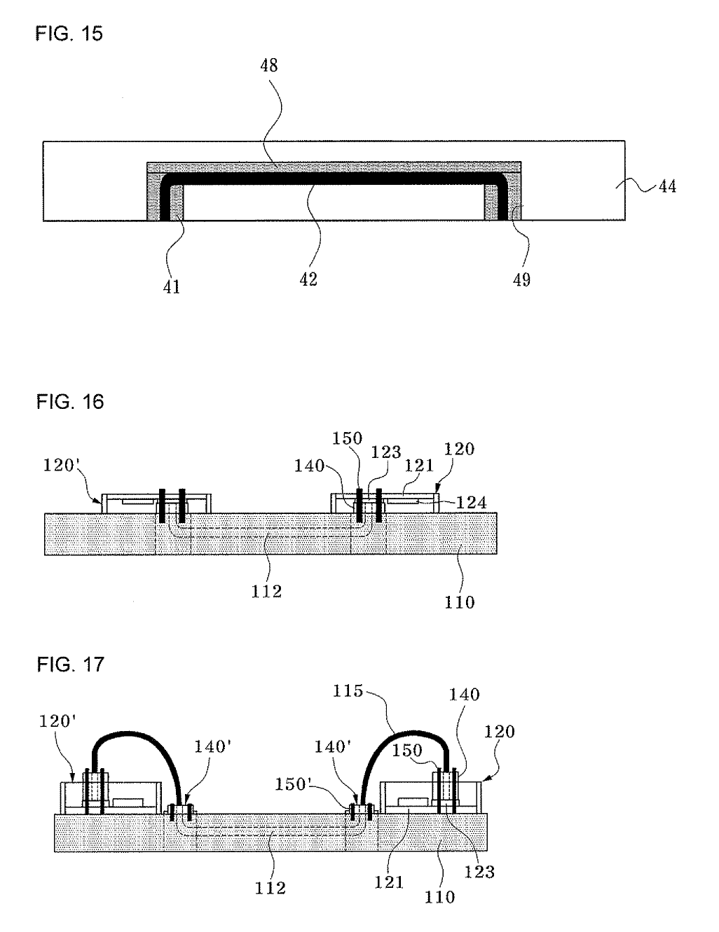

Accordingly, an assembly is manufactured by forming the integrated optical waveguide component 43 in which the bent portions of the optical waveguide 42 are supported by the optical connection ports 41 by connecting the optical connection ports 41 to the bent portions of the ends of the optical waveguide 42, arranging the integrated optical waveguide component 43 such that an array of the optical waveguide 42 extends along the surface of the support 48, and connecting the optical connection ports 41 to the support 48 (FIG. 13). Thereafter, a first board 44a in which through-holes 49 for insertion of the optical connection ports 41 are formed is provided and the integrated optical waveguide component 43 is stacked on the first board 44a. At this time, the optical connection ports 41 are inserted into the through-holes 49. Thereafter, in a state in which the integrated optical waveguide component 43 is disposed in the upper portion of the first board 44a, the second board 44b is stacked and press-formed (see FIG. 14). Accordingly, the optical printed circuit board 44 into which the integrated optical waveguide component 43, the first board 44a, and the second board 44b are integratedly formed is completed (see FIG. 15).

In the methods of manufacturing the optical printed circuit boards illustrated in FIGS. 7 to 15 according to the present invention, the optical connection port of one end of the optical waveguide 32 or 42 is made in the form of the optical connection port 31′ exposed on the side surface of the optical printed circuit board illustrated in FIG. 2B, such that the optical printed circuit board can be manufactured according to the steps illustrated in FIGS. 5, 6, and 7. FIG. 16 is a view of an optical connection structure of an optical module on an optical printed circuit board according to an exemplary embodiment of the present invention. Referring to the figure, an optical module 120 or 120′ is mounted and optically connected on an optical printed circuit board 110 using guide pins 150. The optical module 120 includes an optical module board 121 and optical devices 123 such as a light emitting device or a light receiving device packaged on the optical module board 121. On the optical module board 121, a drive IC for driving the light emitting device and a receiving IC for driving the light receiving device are integrated. The drive IC and the receiving IC are collectively referred to as photoelectric devices 124. As shown in FIGS. 1, 2, and 5, the optical printed circuit board 110 includes an optical waveguide of at least one channel and has guide holes for inserting guide pins into a surface. The optical printed circuit board 110 includes the optical waveguide 112 of which an end surface extends to be exposed on the surface of the optical printed circuit board without an intermediate disconnection. In the optical printed circuit board 10, a vertically changed path is formed.

According to the present invention, the optical module 120 includes an internal optical connection block 140 into which an optical waveguide such as an optical fiber of one or two channels is inserted. At least two guide holes are formed in each of the optical module board 121 and the optical connection block 140 that are optically aligned and assembled by the guide pins 150 inserted through the guide holes. The guide pins 150 are inserted extending to the guide holes formed in the optical printed circuit board 10. Through the guide pins 150, the optical module 120 is mounted on the optical printed circuit board 110 and simultaneously optical path alignment between the optical devices, the optical connection block 140, and the optical printed circuit board 110 is made. Accordingly, the assembly process and the optical alignment can be simple and convenient and high connection efficiency can be provided.

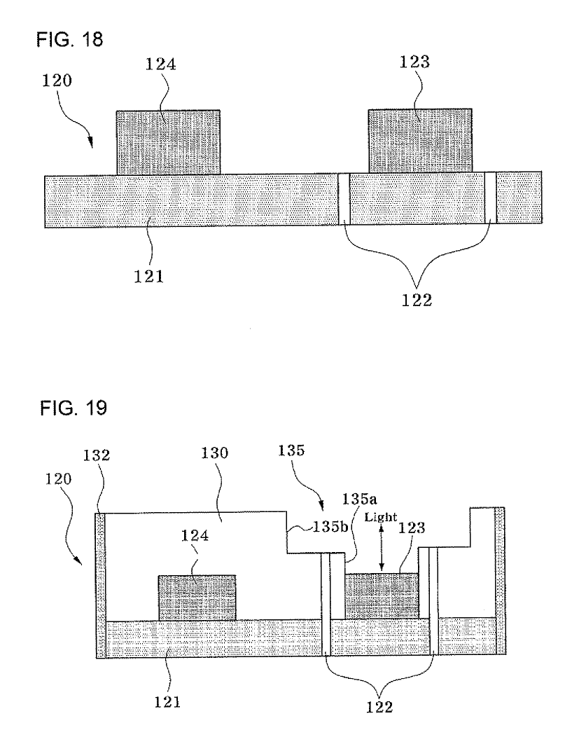

FIG. 17 is a view of an optical connection structure of an optical module on the optical printed circuit board according to another exemplary embodiment of the present invention. When the exemplary embodiment shown in FIG. 17 is compared with the exemplary embodiment shown in FIG. 16, the optical module 120 or 120′ is mounted on a portion different from a portion on which the end surface of the optical waveguide 112 is exposed on the optical printed circuit board 110. A second optical connection block 140′ is mounted on the end surface of the optical waveguide 112. The optical connection block 140 and the second optical connection block 140′ of the optical modules 120 and 120′ are connected to the optical fiber 115.
As shown in the figure, the optical alignment between the optical device 123 and the optical connection block 140 in the optical module 120 and the optical alignment and assembly of the second optical connection block 140′ and the optical printed circuit board 110 are made by the guide pins 150 and 150′. The guide holes are aligned and formed in a board 121 of the optical module 120 and the optical connection block 140. The guide holes may be also aligned and formed in the second optical connection block 140′ and the optical printed circuit board 110. According to this exemplary embodiment, the optical module 120 can be freely installed on the optical printed circuit board 110 without being limited to any position, thereby maximizing space utility of the optical printed circuit board and providing high optical connection efficiency.
FIGS. 18 to 20 are views of an optical module structure according to an exemplary embodiment of the present invention.

First, referring to FIG. 18, an optical module 120 includes an optical module board 121 and an optical device 123 and a photoelectric device 124 integrated on the optical module board 121. The optical device 123 and the photoelectric device 124 are packaged on the upper surface of the board 121 and connected to each other by a gold wire (not shown). For the optical device 123 to be optically connected to another optical component, at least two guide holes 122 for inserting guide pins are formed. The guide holes 122 are aligned with guide holes formed in the optical printed circuit board and other optical component. Through the guide holes 122, the guide pins are inserted. The guide holes 122 can be formed by mechanical drilling or laser drilling. The connection and optical alignment with the other optical component can be easily made using the guide pins.

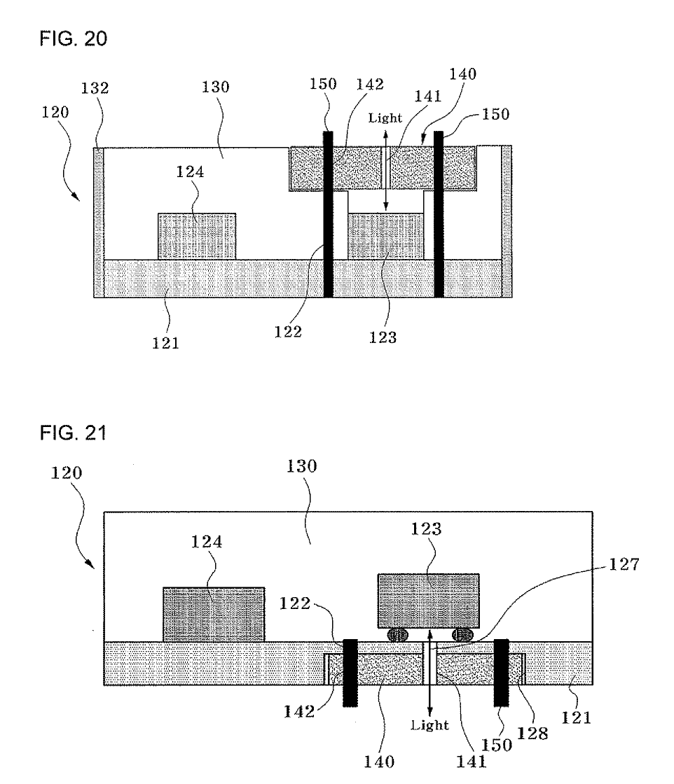

Referring to FIGS. 19 and 20, the optical module according to the present invention further includes a protective layer 130 formed of a filling material such as epoxy resin covering the board 121 into which the optical device 123 and the photoelectric device 124 are packaged.

Referring to the figure, sidewalls 132 are formed on both side surfaces of the board 121 on which the optical device 123 and the photoelectric device 124 are mounted. The protective layer 130 is formed by filling a space between the sidewalls 132 with the filling material. The protective layer 130 protects the optical device and gold wires for connecting optical devices from external environments and improves the durability of the optical module.

According to the present invention, a mounting groove 135 for mounting the optical connection block 140 is formed in the protective layer 130. The mounting groove 135 is formed over the optical device 123 to be optically connected to the optical connection block 140 and includes a first groove 135a formed on the optical device 123 and a second groove 135b connected to the upper portion of the first groove 135a and extending further to the side surface than the first groove 135a. Since the second groove 135b extends further to the side surface than the first groove 135a, the mounting groove 135 internally has a stepped shape. Accordingly, the optical connection block 140 can be seated on a bottom surface of the second groove 135b. When the optical connection block 140 is seated on the mounting groove 135, the optical device 123 and the optical connection block 140 can be optically connected in a non-contact state. The upper portion of the optical connection block may be covered with the filling material using epoxy resin, etc. FIG. 19 shows a state in which the sidewalls 132 are not removed, but the sidewalls 132 may be removed and the protective layer 130 may be formed without the sidewalls 132.

Since the guide holes 122 formed in the board 121 extend in the protective layer 130, the guide holes 122 are continuous in the protective layer 130 and the optical module board 121. The guide pins 150 are inserted through the guide holes 122.

FIG. 20 shows a state in which the optical connection block 140 is mounted on the optical module 120. The optical connection block 140 includes an optical waveguide 141 for guiding light at the center. The optical waveguide is made of an optical fiber or polymer optical waveguide. In the optical connection block 140, guide holes 142 aligned with the guide holes 122 of the optical module 120 are formed. The guide pins 150 are inserted through the guide holes 122 and 142. The optical connection block 140 is mounted in a state separated from the optical device in this structure, thereby preventing deformation, destruction, and component performance degradation due to direct contact between the optical device 123 and the optical connection block 140. Since optical alignment by the guide pins 150 may be relatively simply and correctly made, optical efficiency is improved. FIG. 16 shows a state in which the optical module shown in FIG. 20 is mounted on the optical printed circuit board. The optical module is reversed from the state of FIG. 20 and placed on the optical printed circuit board 110. The guide pins 150 extend and are inserted into the guide holes on the optical printed circuit board 110, thereby making the assembly and optical connection.

FIG. 21 is a view of an optical module structure according to another exemplary embodiment of the present invention.

Referring to the figure, a protective layer 130 is formed by covering an upper portion of an optical module board 121 with a filling material. At this time, an optical device 123 and a photoelectric device 124 are completely covered with the protective layer 130. The figure shows the photoelectric device 124 in a die bonding state at one side and the optical device 123 in a flip-chip bonding state at the other side, but the present invention is not limited to a bonding method. A space between the optical device 123 and the board 121 may be set to an empty free space and filled with a protective layer of a material such as epoxy resin for an optical waveguide.

In a lower surface of the optical module board 121 below the optically connected optical device 123, a connection groove 128 for mounting the optical connection block 140 is formed. In the connection groove 128, a through-hole 127 optically aligned with an optical waveguide 141 of the optical connection block 140 is formed to pass through the optical module board. The through-hole 127 is optically aligned with the optical waveguide 141 of the optical connection block 140. The optical connection block 140 has two guide holes 142 around the optical waveguide 141 embedded into a center portion. Also in the optical module board 121, guide holes 122 aligned with the guide holes 142 of the optical connection block 140 are formed and guide pins 140 are inserted into the guide holes. The guide pins 140 extend below and are inserted into the guide holes of the optical printed circuit board, thereby completing assembly and optical alignment.

Unlike the optical connection structure of the optical module shown in FIG. 16, the optical module shown in FIG. 21 can be mounted in a state in which the optical device is placed on the optical printed circuit board 110, thereby easily detecting a state of the optical device.

Although the present invention has been described in considerable detail with reference to certain preferred versions thereof, other versions are possible. Therefore, the spirit and scope of the appended claims should not be limited to the description of the preferred versions contained therein.

What is claimed is:

1. An optical printed circuit board comprising:
an optical waveguide of at least one channel formed therein,
wherein the optical waveguide of the at least one channel is stacked in the optical printed circuit board, has both ends exposed on a surface of the optical printed circuit board and a predetermined length, and includes a horizontal region bent and extending horizontally from at least one side toward an upper surface of the board and a vertical region extending toward the upper surface of the board.

2. The optical printed circuit board of claim 1, wherein at least one end of the optical waveguide is connected to an optical connection port for supporting the end of the optical waveguide, and the optical connection port connected to the optical waveguide is formed as a unity with the optical printed circuit board.

3. The optical printed circuit board of claim 2, wherein optical connection ports for supporting the ends of the optical waveguide are provided at the both ends of the optical waveguide, an end surface of the optical waveguide is exposed on the upper surface of the board through one optical connection port of the optical connection ports, and an end surface of the optical waveguide is exposed on a side surface of the board through the other optical connection port of the optical connection ports.

4. The optical printed circuit board of claim 2 or 3, wherein at least one optical connection port supports a bent portion of the optical waveguide.

5. The optical printed circuit board of claim 4, further comprising:
a support for supporting the horizontal region of the optical waveguide,
wherein the optical connection port is connected to the support.

6. The optical printed circuit board of claim 2 or 3, wherein the optical connection port linearly supports the optical waveguide, and the optical waveguide is bent between the horizontal region and the optical connection port.

7. The optical printed circuit board of claim 2 or 3, wherein at least two guide holes or at least two guide pins for guiding optical alignment with an optical component to be mounted are formed in an upper or side surface of the optical printed circuit board or a surface of the optical connection port adjacent to an end surface of the optical waveguide.

8. The optical printed circuit board of claim 7, wherein the guide holes or pins are connected to corresponding guide pins or holes and thus the optical waveguides are optically aligned and connected to each other.

9. The optical printed circuit board of claim 8, wherein the guide pins and holes are formed of conductive materials, and power is supplied through the connection of the guide pins and holes.

10. A method of manufacturing an optical printed circuit board, comprising:
(a) connecting an optical connection port to a bent portion of an end of an optical waveguide to manufacture an integrated optical waveguide component;
(b) providing a first board in which a through-hole for inserting the optical connection port is formed;
(c) inserting the optical connection port into the through-hole to stack the integrated optical waveguide component on the first board, with an end surface of the optical waveguide exposed on a board surface; and
(d) stacking and press-forming a second board on the first board having the integrated waveguide component disposed therein.

11. The method of claim 10, wherein a support for supporting the integrated optical waveguide component is provided, and the step (a) comprises: arranging a horizontal region of the optical waveguide on the support and connecting the optical connection port to the support to have an assembly form.

12. A method of manufacturing an optical printed circuit board, comprising:
(a) connecting an optical connection port for linearly supporting an end of an optical waveguide to manufacture an integrated optical waveguide component;
(b) providing a first board in which a through-hole for inserting the optical connection port is formed;
(c) bending the optical waveguide, inserting the optical connection port into the through-hole to expose an end surface of the optical waveguide on a board surface, and stacking the integrated optical waveguide component on the first board; and
(d) stacking and press-forming a second board on the first board having the integrated waveguide component disposed therein.

13. An optical module optically connectable to an optical printed circuit board, comprising:
an optical module board in which at least one optical device is integrated and at least two guide holes are formed; and
an optical connection block having at least one optical waveguide as an optical path and at least two guide holes aligned with the guide holes of the board,
wherein optical path alignment between the optical module and another optical component is provided by guide pins inserted through the guide holes of the optical module board and the optical connection block and guide holes formed in the optical printed circuit board to which the optical module is connected.

14. The optical module of claim 13, further comprising:
a protective layer formed of a filling material which covers the optical module board.

15. The optical module of claim 13 or 14, wherein a drive IC for driving a light emitting device and a receiving IC for driving a light receiving device are integrated into the optical module board.

16. The optical module of claim 14, further comprising a mounting groove formed in the protective layer of the board for mounting the optical connection block over the at least one optical device,
wherein the mounting groove having a first groove formed on the optical device and a second groove connected to an upper portion of the first groove and extending further than the first groove is formed in a stepped shape and the guide holes of the optical module board are formed to extend to the protective layer.

17. The optical module of claim 13 or 14, wherein a connection groove for placing the optical connection block is formed in a lower surface of the optical module board below the optical device, a through-hole optically aligned with the optical waveguide of the optical connection block is formed in the connection groove, and optical path alignment is provided by guide pins inserted through the guide holes of the optical module board and the optical connection block.

18. An optical connection structure of an optical module on an optical printed circuit board, comprising:
the optical module comprising: an optical module board in which at least one optical device is integrated and at least two guide holes are formed; at least one optical waveguide as an optical path and at least two guide holes aligned with the guide holes of the optical module board; and guide pins inserted through the guide holes,
wherein the optical module is mounted on a portion separated from an end surface of the optical waveguide on a surface of the optical printed circuit board,
a second optical connection block is optically aligned and mounted by the guide pins over the end surface of the optical waveguide of the optical printed circuit board, and
an optical connection block of the optical module and the second optical connection block are connected by an optical fiber.
